(19) United States
(12) Patent Application Publication
(10) Pub. No.: US 2002/0174206 A1
(43) Pub. Date: Nov. 21, 2002

(54) Web-based file manipulating system

(76) Inventors: Alan L. Moyer, Chelmsford, MA (US); Orlando Lopez, Topsfield, MA (US)

Correspondence Address: Orlando Lopez, POLAROID CORPORATION, Patent Department, 784 Memorial Drive, Cambridge, MA, 02139, US

(21) Appl. No.: 09/861,792

(22) Filed: May 21, 2001

(51) Int. Cl. G06F 15/177

(52) U.S. Cl. 709/221

(57) ABSTRACT

Method and apparatus are provided for manipulating (deleting, downloading to) information from a peripheral device (such as a digital camera or a scanner) through a client computer. A software component within a client application executing on the client computer installs a peripheral device driver for operating the peripheral device on the client computer without re-executing the client application. The software component transfers the information from the peripheral device to the client computer using the peripheral device driver and manipulates, processes the information, uploads the processed information to a web site, or stores the processed information in the client computer without re-executing the client application.

### BACKGROUND OF THE INVENTION

1. Field of the Invention

The present invention relates to transmission of information over networks and, more particularly, to manipulating digital files in a peripheral connected to a client computer where the client receives inputs regarding the manipulation from a server.

2. Related Art

The World Wide Web (“the Web”) is one of a variety of services available over the public Internet. In its early stages the Web was used primarily to share static information such as technical papers and indices of documents available at research institutions, libraries, and government agencies. Someone wishing to make a document available on the Web could store the document on a web server at a particular Internet Protocol (IP) address specified by a Uniform Resource Locator (URL), and other users could view or “browse” the document over the Internet using client software referred to as a web browser by pointing the web browser to the document's URL.

Although the Web's capabilities have grown substantially in recent years, the basic underlying technological mechanisms for exchanging information between web clients and servers have remained substantially unchanged. When a user requests that a web page be displayed by a web client (typically referred to as a “web browser”), the web browser transmits a request, defined according to the Hypertext Transfer Protocol (HTTP), for the web page to the web server that hosts the web page. In response to the request, the web server transmits the requested web page to the requesting web browser in a response message that is also defined according to HTTP. The web browser displays the web page to the user based on the information contained in the response from the web server.

Web sites are increasingly being used to provide public and private forums in which users may share information and engage in group activities. For example, some web sites provide virtual message boards and chat rooms in which users may post messages and view messages that have been posted by other users, thereby allowing users to engage in online conversations. Furthermore, some web sites allow users to upload files and other information from their local computers to the web site for storage, sharing, distribution, and/or collaboration. For example, some web sites allow users to upload digital images to the web site for storage in a virtual photo album. The virtual photo album may then be viewed over the Internet using a standard web browser. Other web sites provide online backup services that allow users to upload files to the web site for off-site storage.

Web sites that allow users to upload information typically require the user to be responsible for acquiring the information to be uploaded and for storing the information on the user's local computer in an appropriate format prior to uploading the information to the web site. For example, web sites that allow users to upload digital images into a virtual photo album typically require the user to be responsible for taking any steps necessary to acquiring and store the digital images on the user's local computer. Such web sites typically use conventional techniques to upload such (appropriately acquired and stored) information from the local (client) computer to the web site. Such web sites typically do not assist the user in acquiring the information to be uploaded or in storing the information in a format appropriate for uploading.

Acquiring and storing information on the client computer may require a significant amount of effort by the user. For example, in the case of digital images, the user typically acquires the images with a digital camera and transfers the images to the client computer. Before the images may be transferred from the digital camera to the client computer, however, the user must typically manually install appropriate driver software on the client computer to enable the digital camera to communicate with the client computer. The driver software is typically designed specifically for use with a particular brand and model of digital camera and is provided by the manufacturer of the digital camera on a computer-readable medium such as a floppy disk or CD-ROM. To install the driver software on the client computer, the user must typically run installation software from the floppy disk or CD-ROM and follow the installation instructions that are provided. The client computer must typically be rebooted after the driver software is installed before the digital camera may be used with the client computer. Other computer peripherals typically require similar installation procedures.

As described above, conventional web sites assume that any information to be uploaded is already stored on the client computer in an appropriate format. Therefore, the user must typically perform two manual steps before uploading information from a peripheral device (such as a digital camera) to a conventional web site: (1) install appropriate driver software on the client computer, as described above, and (2) transfer the information to be uploaded from the peripheral device to the client computer. Transferring the information from the peripheral device to the client computer may require the use of software (in addition to the peripheral device driver software) that is provided by the manufacturer of the peripheral device or by a third party and that may also require separate installation by the user on the client computer.

In other cases, web sites send verification of a transaction to the client computer and enable manipulation of the files at the peripheral, such as deleting information at the peripheral or downloading information to the peripheral. For example, the system disclosed in U.S. patent application Ser. No.AA/AAA, AAA, “Method and System for Enabling the Use of Reloadable Single Use Digital Cameras”, filed on this same date, requires enabling the deletion of files from a camera connected to the client computer upon receiving transaction verification from a server. Other examples exist of downloading information to a peripheral upon receiving transaction verification from a server. In these cases, the user must typically perform two manual steps before deleting information from a peripheral device (such as a digital camera) or downloading information to a peripheral device. The user must: (1) install appropriate driver software on the client computer, as described above, and (2) delete or download the information from the peripheral device connected to the client computer. Deleting or downloading the information from the peripheral device connected to the client computer may require the use of application software (in addition to the peripheral device driver software) and that may also require separate installation by the user on the client computer.

What is needed, therefore, is a system that facilitates the process of manipulating information at a peripheral device.

### SUMMARY

In one general aspect, the present invention provides a computer implemented method for manipulating information (such as digital images) at a peripheral device (such as a digital camera or scanner) connected to a client computer upon receiving information from a server. After connecting the peripheral device to the client computer, the user may use a conventional web browser installed on the client computer to navigate to a predetermined web site that has been designed to assist the user in manipulating information at the peripheral device. The web site includes a software component, such as a Java applet, that is downloaded to the client computer and executed within the web browser without requiring the client computer to be rebooted or the web browser to be re-executed. The software component initiates a transaction with a web server, receives confirmation of the transaction, receives data from the same or another web server (via the web browser) and manipulates the information in the peripheral device upon receiving the data from the web server.

The software component determines whether a peripheral device driver for operating the peripheral device is already installed on the client computer. If the software component determines that the peripheral device driver is not already installed on the client computer, the software component downloads the peripheral device driver from a peripheral device driver server and installs the peripheral device driver on the client computer without rebooting the client computer and without re-executing the web browser.

The user may select information (such as digital images) for processing and/or uploading to the web site after processing. Interaction between the user and the software component occurs through the web browser interface, thereby avoiding the need to install and execute a separate application program on the client computer for selecting and/or uploading images.

After the user has processed the selected information (if processing is desired), the software component uploads the selected information to a device data database (which may be integrated into the same web site used to select the information). After processing and/or uploading the selected information, the software component presents the user with the option of deleting the peripheral device driver from the client computer. If the user chooses to delete the peripheral device driver, it is deleted without rebooting the client computer and without re-executing the web browser. The software component may also be deleted from the client computer without rebooting the client computer and/or without re-executing the web browser. Java applets, for example, are typically removed automatically from the client computer upon exiting the web browser.

Additional aspects and embodiments of the present invention will be described in more detailed below.

### BRIEF DESCRIPTION OF THE DRAWINGS

FIG. 1 is a dataflow diagram of a computer system according to one embodiment of the present invention.

FIGS. 2A-2C are dataflow diagrams of computer systems according to various embodiments of the present invention.

FIGS. 3A-3D are flow charts of methods performed by various embodiments of the present invention to transfer information from a peripheral device to a client computer and to upload the transferred information from the client computer to a web site.

FIG. 4 is a flow chart of a method for installing a peripheral device driver on a client computer without rebooting the client computer according to one embodiment of the present invention.

FIG. 5 is a dataflow diagram illustrating communications among a web browser, a peripheral device driver, and a peripheral device according to one embodiment of the present invention.

### DETAILED DESCRIPTION

In one general aspect, the present invention provides a computer implemented method for manipulating information (such as digital images) at a peripheral device (such as a digital camera or scanner) connected to a client computer. As used below, manipulation of information includes deleting information from the peripheral, downloading information to the peripheral, or performing processing operations on the information from the peripheral device. After connecting the peripheral device to the client computer, the user may use a conventional web browser installed on the client computer to navigate to a predetermined web site at a web server. The web site has been designed to assist the user in the manipulation of the information at the peripheral. The web site includes a software component, such as a Java applet, that is downloaded to the client computer and executed within the web browser without requiring the client computer to be rebooted or the web browser to be re-executed. In commonly assigned U.S. patent application Ser. No. 09/653,597, filed on Aug. 31, 2000, entitled “Web Based File Upload System”, hereby incorporated by reference herein, a computer implemented method for uploading information (such as digital images) from a peripheral device (such as a digital camera or scanner) to a web site through a client computer is disclosed. In the present invention, the software component in the computer implemented method is designed such that the manipulation of the information at the peripheral device is enabled upon receiving enabling information from a server.

The software component determines whether a peripheral device driver for operating the peripheral device is already installed on the client computer. If the software component determines that the peripheral device driver is not already installed on the client computer, the software component downloads the peripheral device driver from a peripheral device driver server and installs the peripheral device driver on the client computer without rebooting the client computer and without reexecuting the web browser

In order to describe the advantages of a detailed embodiment of this invention, the system and method disclosed in U.S. patent application Ser. No. AA/AAA,AAA, “Method and System for Enabling the Use of Reloadable Single Use Digital Camera, filed on this same date, is used as example. In Ser. No. ______, a method of enabling the use of a reloadable single use digital camera for acquiring and storing data corresponding to images and thereafter providing a customer means for retrieving selected images from the stored data upon the customer transmitting the data to a reloading server, comprising the steps of: providing the customer a reloadable single use digital camera of the type that electronically records and stores data corresponding to images selected by the customer, and provides no means for the customer to retrieve the data in image form from the digital camera, receiving the data corresponding to selected images from the customer after the customer has utilized the digital camera to acquire and store data corresponding to images and, thereafter, retrieving selected images from the data for the customer is disclosed. In another aspect of the invention in U.S. patent application Ser. No. AA/AAA,AAA, the method further comprises the step of transmitting enabling information from a server, the information enabling the removing of selected ones of the data from the digital camera after it has been utilized by the customer to acquire and record data corresponding to images, thereby preparing the camera for re-use. The removing (deleting) of the selected ones of the data from the camera occurs while the camera (or the removable storage in the camera) is interfaced to a computer at a client site, thereby enabling the customer to prepare the camera for re-use. Using the techniques described herein, the customer can retrieve or delete selected images through multiple client computers without needing to manually install driver software on the multiple client computers.

In one embodiment of the invention in U.S. patent application Ser. No. AA/AAA,AAA, after the consumer selects the data to retrieve as images, the software component retrieves the data in image form. (Retrieval occurs through processing operations such as decryption.) If the consumer selects to upload the images to an image database (which may be integrated into the same web site used to download the software component), the software component uploads the selected images to the image database. If the customer selects to “reload” the camera, selected data corresponding to digital images are removed from memory in the camera and deleted from the camera. Before this operation can be enabled, the customer must provide payment for the continued re-use of the camera. The customer sends payment information to a server (which could be a different server from the server which was used download the software component) at which the transaction is processed. This transaction and its processing occur through means that are well known in the art. Upon successfully processing the transaction, the client computer receives enabling information from the server. Upon receipt of the enabling information, the software component deletes from the memory in the camera the selected data and the camera is ready for re-use.

In the present invention, the device driver may be deleted from a client computer after the consumer has completed the retrieval, upload or removal of the digital images. The deletion may occur automatically at the end of the process. As a result, the client computer may be restored to the state that it was in prior to its use for the retrieval, upload or removal of the digital images from the single use camera. In this way, the consumer may use the client computer as a temporary station to retrieve, upload or remove the digital images from the single use camera without permanently installing the device driver or software application on the client computer and without permanently storing the digital images on the client computer. This feature may be advantageous when, for example, the consumer is borrowing someone else's computer or using a client computer in a public place such as a cafe or an Internet kiosk, where permanent modification of the client computer is undesirable or not allowed. Thus, the present invention can simplify and enhance the use of the system described in U.S. patent application Ser. No. AA/AAA,AAA.

As described in more detail below, a software component executing within a conventional web browser may be used to perform functions such as installing the peripheral device driver on the client computer, retrieving, uploading or removing the digital images from the single use camera. The software component may, for example, be a Java applet.

Use of a software component, such as an applet, executing within a client application, such as a web browser, provides several advantages. For example, because an applet contained in a web page is automatically downloaded to the client computer by the web browser, it is not necessary for the user to manually install the applet or to provide the applet on a computer-readable medium such as a floppy disk or CD-ROM. Furthermore, within the Microsoft Windows environment, download and execution of an applet does not involve the installation of any DLLs on the client computer that could potentially cause backward compatibility problems with existing applications. Furthermore, installation of an applet does not involve modifications to the Windows registry which might require the client computer to be rebooted.

Because applets execute within a web browser, applets may take advantage of functionality that is already installed on the client computer as part of the web browser. As a result, applets are typically smaller than corresponding application programs, resulting in shorter download times and storage requirements for applets than for application programs. Because conventional web browsers are already installed on the vast majority of client computers, applets and similar software components may advantageously be used to implement various features described herein on a large number of existing client computers without requiring the download or installation of large application programs.

Similarly, because applets execute within a web browser, execution of an applet does not require the execution of a separate application program on the client computer. Rather, applets typically provide output and receive input through a web browser that is already executing on the client computer. As a result, applets and similar software components may be used to implement various features described herein within a single integrated web site for assisting in the manipulation of information (such as data corresponding to images) from a peripheral device.

A further advantage of using applets and similar software components is that they are typically uninstalled automatically (i.e., without requiring the user to execute an “uninstall” command) and without requiring the client computer to be rebooted or the web browser to be re-executed. For example, an applet contained within a web page is typically removed automatically from the client computer's memory when the user navigates to another web page. This further simplifies the user's experience of uploading information and reduces the impact on the client computer by removing applet-related data from the client computer after the user has completed the upload process.

As described above, in one embodiment an appropriate peripheral device driver is automatically downloaded from a peripheral device driver server to the client computer over a TCP/IP network, such as the Internet, without requiring intervention by the user. This feature simplifies the process of installing the peripheral device driver compared to conventional installation procedures, which typically require the user to perform manual actions such as providing a floppy disk or CD-ROM, running driver installation software, and following instructions provided by the driver installation software. In addition to relieving the user of the burden of manually installing the peripheral device driver, automatic installation may also reduce the amount of time needed to install the peripheral device driver and therefore reduce the amount of time that the user must wait to first use the peripheral device with the client computer.

As described above, in one embodiment the peripheral device driver is downloaded to and installed on the client computer only if the peripheral device driver is not already installed on the client computer. As a result, the peripheral device driver is only transferred to and installed on the client computer when necessary. This results in efficient use of network bandwidth by only transferring the peripheral device driver across the TCP/IP network when necessary. This technique may also be used to reinstall the peripheral device driver when necessary, such as when the peripheral device driver has become corrupted or needs to be updated.

In a further embodiment, the peripheral device that is connected to the client computer is identified, and an appropriate peripheral device driver is selected for installation on the client computer based on the identification. Such automatic identification relieves the user of the responsibility for determining which peripheral device is connected to the client computer and for identifying the peripheral device. Automatic identification of the peripheral device may eliminate errors that may be made by the user in identifying the peripheral device, such as incorrect identification of the peripheral device's model number or version number.

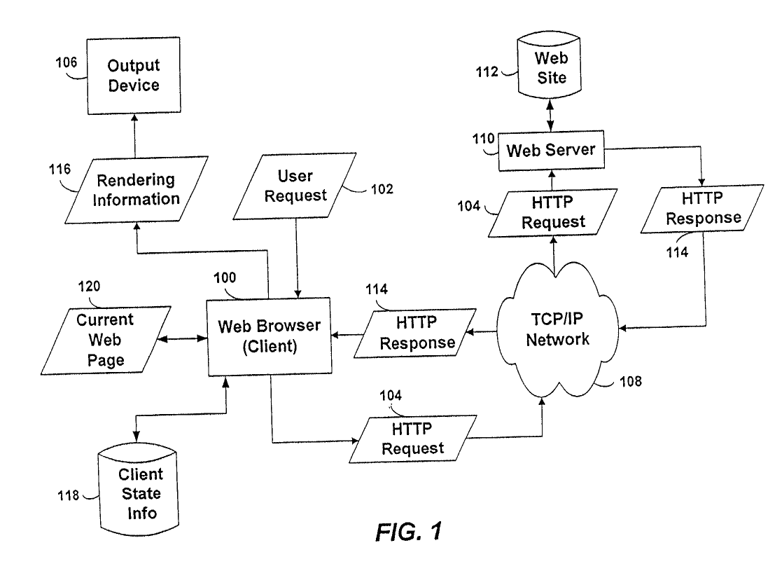

Various aspects and features of embodiments of the present invention will be described in more detail below. First, however, a system in which embodiments of the present invention may operate is described with respect to FIG. 1.

Referring to FIG. 1, a dataflow diagram is shown that illustrates at a high level various techniques that may be employed to transmit information between a web client and web server over a TCP/IP network in conjunction with various embodiments of the present invention. A user accesses information made available by a web server 110 through client software typically referred to as a web browser 100. The web browser 100 typically executes on a computer such as a conventional desktop computer. To view a particular web page, the user submits a request 102 to the web browser 100 to view the web page. The user may make the request 102 in any of a variety of ways, such as by typing the URL of the web page into the web browser 100 or by clicking on a hyperlink to the web page in a web page currently displayed by the web browser 100. The web browser 100 parses the user request 102 to identify the URL of the requested web page and generates a request 104 for the web page according to the Hypertext Transfer Protocol (HTTP).

HTTP is the language that web clients (browsers) and web servers use to communicate with each other. More specifically, HTTP defines the set of rules for exchanging information (e.g., text, graphic images, sound, or video) on the Web. Messages transmitted between web clients and web servers, therefore, are defined and exchanged according to the rules specified by HTTP. HTTP is transferred as a layer on top of the Transmission Control Protocol/Internet Protocol (TCP/IP), which is the suite of communications protocols used to connect hosts on the Internet. Other services available over the Internet, such as electronic mail and file transfer also employ protocols, such as Post Office Protocol (POP) and File Transfer Protocol (FTP), that are transmitted as layers over TCP/IP.

The HTTP request 104 requests that the web page at the URL specified by the user request 102 be delivered to the web browser 100 for display on an output device 106 (which may, for example, be a computer monitor). The web browser 100 transmits the HTTP request 104 over a TCP/IP network 108 which may, for example, be the public Internet or a private intranet. The client computer on which the web browser 100 executes is typically connected to the TCP/IP network by conventional means such as an analog telephone line or T1 connection. The TCP/IP network 108 routes the HTTP request 104, using techniques that are well known to those of ordinary skill in the art, to a web server 110 that hosts the web page requested by the user request 102. The web server 110 may be implemented, for example, in software executing on a conventional computer. For purposes of illustration, the web server 110 is shown in FIG. 1 as hosting a particular web site 112 that includes any number of interrelated web pages. It should be appreciated that the web server 110 may host additional web sites and that additional web servers and web sites may be accessible through the TCP/IP network 108. The web server 110 parses the HTTP request 104 to identify the sender of the HTTP request 104 (i.e., the web browser 100) and to determine which web page in the web site 112 is requested.

The Hypertext Markup Language (HTML) is the language in which web pages are written. For example, the web pages in the web site 112 are typically defined using HTML. Although a variety of other proprietary and non-proprietary standards for enhancing web pages have been developed over the years, HTML is still the underlying language in which all web pages are defined. Additional languages and technologies are typically implemented as additions to or substitutes for particular features of HTML. After receiving and parsing the HTTP request 104, the web server 110 extracts from the web site 112 the HTML code corresponding to the requested web page. The web server transmits to the web browser 100, over the TCP/IP network 108, an HTTP response 114 including the extracted HTML.

The TCP/IP network 108 routes the HTTP response 114 to the web browser 100 using techniques well known to those of ordinary skill in the art. The web browser 100 parses the HTTP response 114 and extracts from it the requested web page's HTML code. The web browser 100 may locally store a copy of the requested page's HTML code as a current web page 120 to facilitate further processing of and interaction with the current web page 120. The web browser 100 parses the HTML to generate rendering information 116 that the web browser 100 delivers to the output device 106 for display to the user. Thus, the web page requested by the user is displayed.

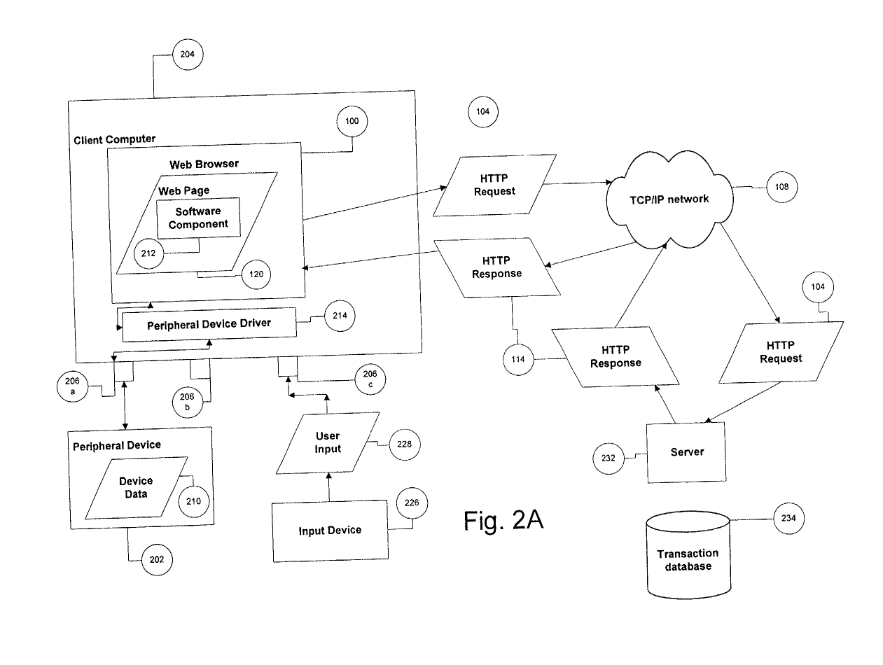

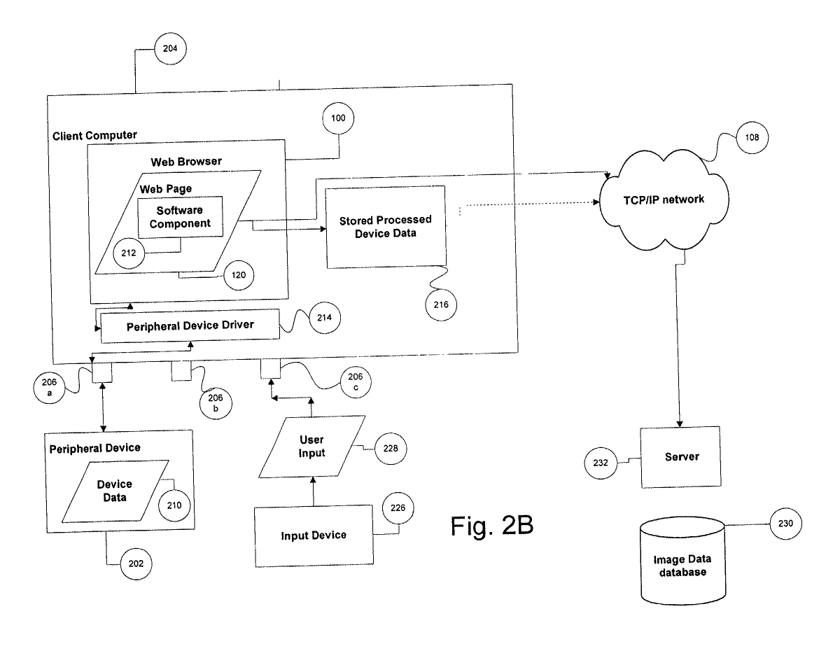

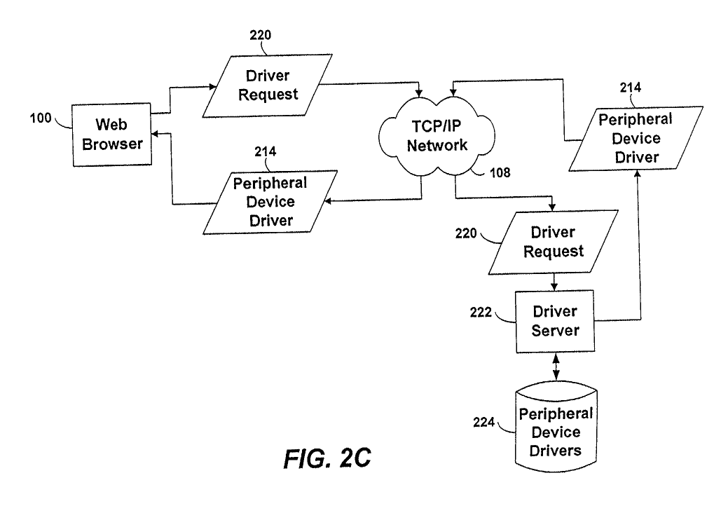

Various embodiments of the present invention will now be described in more detail. Referring to FIG. 2A, in one embodiment, a user connects a peripheral device 202, such as a single use digital camera as described in U.S. patent application Ser. No. AA/AAA,AAA, “Method and System for Enabling the Use of Reloadable Single Use Digital Camera, to a client computer 204 through an input/output port 206a. The input/output port 206a may, for example, be a serial port, parallel port, Universal Serial Bus (USB) port, or a wireless communications port.

As shown in FIG. 2A, the peripheral device 202 contains device data 210. In one embodiment the peripheral device 202 is a single use digital camera. The device data 210 includes data corresponding to one or more digital images and is stored in a memory within the single use digital camera as described in U.S. patent application Ser. No. AA/AAA,AAA. The device data 210 may, however, be any data and may be stored on any medium. Furthermore, the device data 210 need not be stored within the peripheral device 202 as shown in FIG. 2A; the device data 210 may, for example, be stored in a computer-readable medium (such as a floppy disk, cartridge, flash memory card, CD-RW or CD-ROM) whose contents are accessible to the peripheral device 202.

By connecting the peripheral device 202 to the port 206a of the client computer 204, the user provides a physical connection through which the client computer 204 and the peripheral device 202 may communicate (such as by sending/receiving commands and transferring the device data 210 from the peripheral device 202 to the client computer 204). Such a physical connection, however, may not be sufficient to enable communication between the client computer 204 and the peripheral device 202 if an appropriate peripheral device driver is not installed on the client computer 204. For example, as shown in FIG. 2A, a peripheral device driver for operating the peripheral device 202 is shown installed on the client computer 204. In one embodiment of the present invention, communication between the client computer 204 and the peripheral device 202 is enabled as follows.

As shown in FIG. 2A, in one embodiment the web browser 100 executes on the client computer 204. It should be appreciated that the web browser 100 is shown in block diagram form within the client computer 204 to indicate that the web browser 100 is stored in a computer-readable memory of the client computer 204 and is being executed by a processor of the client computer 204 using techniques well-known to those of ordinary skill in the art. As a result, the client computer 204 may retrieve web pages from the web site 112 and from other web sites as described above with respect to FIG. 1. In one embodiment, the web site 112 includes one or more interrelated web pages for enabling the user to transfer device data 210 from the peripheral device 202 to the client computer 204 and for manipulating the data. To transfer some or all of the device data 210 to the client computer 204, the user navigates the web browser 100 to a predetermined web page within the web site 112 (such as the web site's home page). Various techniques for implementing the web site 112 are described in more detail below. The web page selected by the user is displayed by the web browser 100 as the current web page 120. Although only the single current web page 120 is shown in FIG. 2A, it should be appreciated that the current web page 120 represents the web page that is currently being displayed by the web browser 100 at any particular point in time. Therefore, the contents of the current web page 120 may change over time as the user navigates through the web site 112 and performs the actions described herein. The user may provide user input 228 (such as navigation commands) through an input device 226 (such as a keyboard or mouse) connected to a port 206c of the client computer 204.

The current web page 120 includes a software component 212 for performing various functions described herein. As described in more detail below, the software component 212 may be any software component that may be executed by the web browser 100, such as a Java applet or an ActiveX control. In one embodiment, when the web browser 100 displays the current web page 120, the web browser 100 also downloads and executes the software component 212.

For purposes of example, for a single use digital camera, the following description refers to actions that may be performed by the web browser 100 to enable the user to transfer the device data 210 to the client computer 204, operate (decrypt the data) on the data and retrieve the data in image form, and delete the data after uploading the images to a server 232 or storing the images at the client computer 204. It should be appreciated that such actions may be performed by the web browser 100 and/or by the software component 212 executing within the web browser 100.

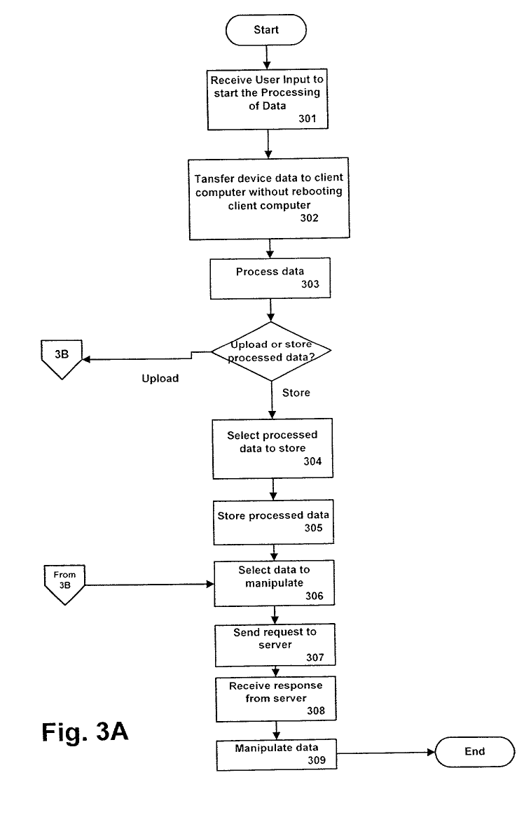

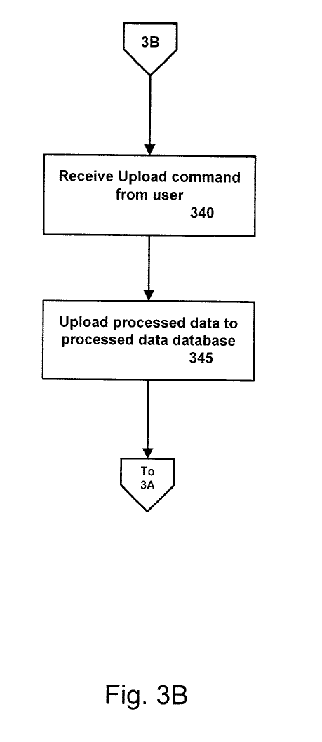

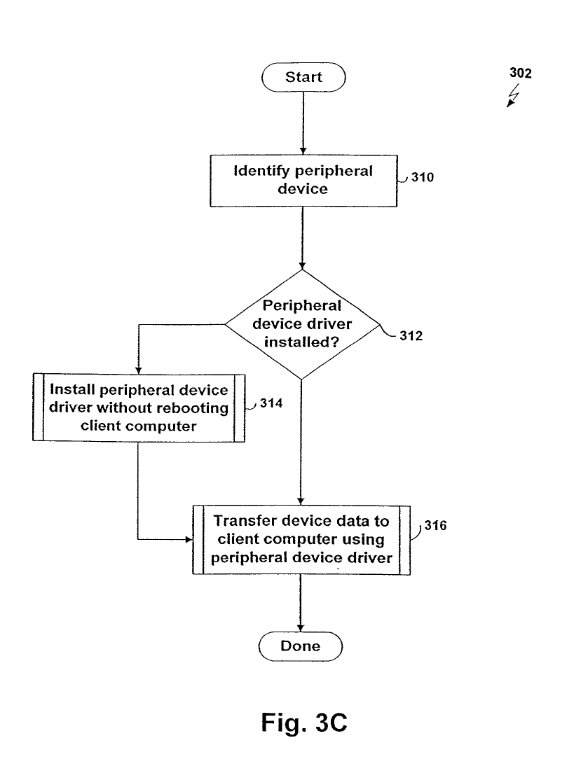

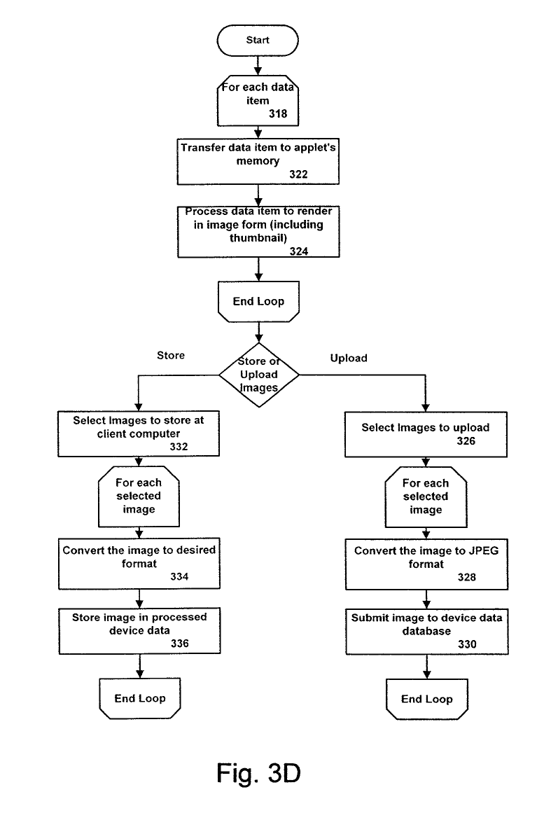

The current web page 120 provides the user with the ability to transfer some or all of the device data 210 to the client computer 204 (step 302). Referring to FIG. 3A, a method 300 is shown that may be performed by the software component 212 downloaded by the browser 100 and which runs in the browser 100 in one embodiment to transfer some or all of the device data 210 from the peripheral device 202 (a single use camera for example) to the client computer 204, operate on the data (retrieves the data in image form, for example), select data to manipulate (delete, for example) and, upon receiving information from the server 232, manipulate the data.

The user provides user input 228 indicating a desire to start the process of retrieving the device data 210 from the peripheral device 202 (such as by clicking on a button displayed on the current web page 120). The web browser 100 receives the user input 228 (step 301). In response to the user input 228, the software component 212 downloaded by the browser 100 and which runs in the browser 100 transfers device data 210 from the peripheral device 202 to the client computer 204 without rebooting the client computer 204 (step 302). (It should be apparent that there are applications in which it is not necessary to transfer the device data 210 to the client computer 204.) The software component 212 processes the transferred device data 210 (step 303). In the single use camera example, the processing retrieves the data in image form. It should be apparent that in some applications no processing is required.

The user can decide to either upload selected processed data to the server 232 or store selected processed data in the client computer 204 (after the data processing of step 303). If the user decides to store selected processed data in the client computer 204, the user provides user input 228 as to which of processed data items to store (such as by clicking on the images displayed on the current web page 120). The web browser 100 receives the users' input 228 as to which of the processed data items to store (step 304). The web browser 100 stores the device data 210 as processed device data 216 (step 305) as shown in FIG. 2B.

Referring to FIG. 3B, if the user decides to upload selected processed data to the server 232, the user provides user input 228 as to which of processed data items to store (such as by clicking on the images displayed on the current web page 120). The web browser 100 receives the users' input 228 as to which of the processed data items to upload (step 340). The web browser uploads the selected processed device data to a processed device data database 230 over the TCP/IP network 108 without rebooting the client computer 204 (step 345). In one embodiment, the selected processed device data is uploaded to the processed device data database 230 without re-executing the web browser 100. It should be apparent that both the upload and storing can be selected. In that case, the web browser uploads the selected processed device data 216 to the processed device data database 230 over the TCP/IP network 108 and stores the device data 210 as processed device data 216. If only upload is selected, the selected processed image can be transmitted from the memory corresponding to the software component 212 to the processed device data database 230.

The user then provides user input 228 as to which of the data items to manipulate (such as by clicking on a “delete” button located by each of the images displayed on the current web page 120). The web browser 100 receives the users' input as to which of the data items to manipulate (step 306). A request 104 is then sent to the server 232 (step 307). In the single use camera example, the request involves payment information for re-use of the camera. The server processes the request and sends a response 114 back to the web browser 100. In the single use camera example, the server performs a verification on the payment information and a transaction and the response indicates the success of the transaction. The web browser 100 receives the response 114 (step 308). Upon receiving a positive response, the peripheral device driver 214, under control of the software component 212, manipulates the device data 210 (step 309). In the single use camera example, after receiving verification of payment, the driver 214, under control of the software component 212, deletes the selected data items from the device data 210.

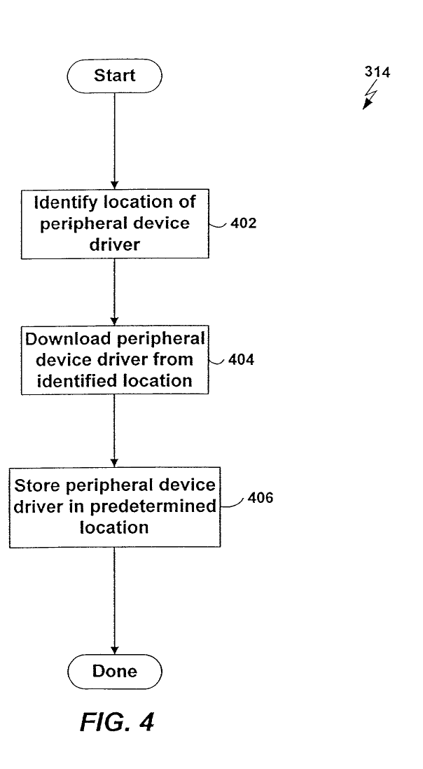

Referring to FIG. 3C, in one embodiment the software component 212 downloaded by the browser 100 and which runs in the browser 100 transfers the device data 210 from the peripheral device 202 to the client computer 204 (step 304) as follows. The web browser 100 and/or the software component 212 downloaded by the browser 100 and which runs in the browser 100 identifies the peripheral device 202 that is connected to the client computer 204 (step 310). The web browser 100 or the software component 212 downloaded by the browser 100 and which runs in the browser 100 may, for example, identify features of the peripheral device, such as its version number, model number, and/or serial number. Various ways in which the web browser 100 and/or the software component 212 downloaded by the browser 100 and which runs in the browser 100 may identify the peripheral device 202 are described in more detail below. Having identified the peripheral device 202, the web browser 100 and/or the software component 212 downloaded by the browser 100 and which runs in the browser 100 determines whether a peripheral device driver for operating the peripheral device 202 is installed on the client computer 204 (step 312). If the web browser 100 and/or the software component 212 downloaded by the browser 100 and which runs in the browser 100 determines that a peripheral device driver for operating the peripheral device 202 is not installed on the client computer 204, the web browser 100 and/or the software component 212 downloaded by the browser 100 and which runs in the browser 100 installs a peripheral device driver for operating the peripheral device 202 without rebooting the client computer 204 (step 314). A peripheral device driver 214 may be installed in step 314 without re-executing the web browser 100. One example of a process that may be used by the web browser 100 and/or the software component 212 downloaded by the browser 100 and which runs in the browser 100 to install the driver software without rebooting the client computer 204 and without re-executing the web browser 100 is described in more detail below with respect to FIG. 4. Referring to FIGS. 2A, 2B, the peripheral device driver 214 is shown as installed on the client computer 204.

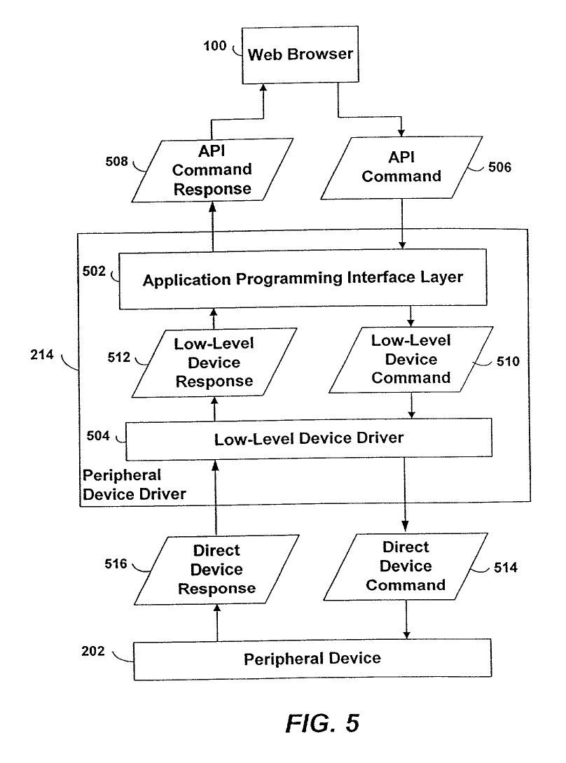

The peripheral device driver 214 acts as an intermediary between the web browser 100 (and/or the software component 212) and the peripheral device 202. As described in more detail below with respect to FIG. 5, all communications between the web browser 100 and/or the software component 212 downloaded by the browser 100 and which runs in the browser 100 and the peripheral device 202 are performed through the peripheral device driver 214. The web browser 100 or the software component 212 downloaded by the browser 100 and which runs in the browser 100 transfers the device data 210 from the peripheral device 202 to the client computer 204 using the peripheral device driver 214 (step 316).

In one embodiment, the peripheral device driver 214 is uninstalled (removed) from the client computer after being used to transfer the device data 210 from the peripheral device 202 to the client computer 204 (step 316). As described in more detail below, the peripheral device driver 214 may be removed from the client computer 204 without rebooting the client computer 204.

It should be appreciated that the techniques described above may be used to allow the user of the web browser 100 to transfer device data 210 (e.g., data corresponding to images) from the peripheral device 202 to the client computer 204 and upload the processed device data from the client computer 204 to the processed device data database 230 without manually installing the peripheral device driver 214 on the client computer 204. Furthermore, it should be appreciated that the device data 210 may be transferred to the client computer 204 and uploaded to the processed device data database 230 without rebooting the client computer 204 and without re-executing the web browser 100, even if the peripheral device driver 214 was not installed on the client computer 204 prior to the transfer and/or upload.

The web browser 100 may upload the processed device data to the processed device data database 230 using techniques that are well-known to those of ordinary skill in the art. The web page 120 may, for example, include a Uniform Resource Locator (URL) of the processed device data database 230 that the web browser 100 may use to locate and access the processed device data database 230. Once the processed device data has been uploaded to the processed device data database 230, the processed device data may be made available for browsing over the TCP/IP network 108 using the web browser 100. For example, in one embodiment the processed device data includes one or more digital images which are provided for viewing on a web site such as the web site 112.

As described above, in one embodiment the web browser 100 and/or the software component 212 downloaded by the browser 100 and which runs in browser 100 identifies the peripheral device 202 that is connected to the client computer 204 (FIG. 3C, step 310). In one embodiment, the web browser 100 and/or the software component 212 downloaded by the browser 100 and which runs in the browser 100 identifies the peripheral device 202 by receiving user input 228 identifying the model of the peripheral device 202. The user may also identify, through the user input 228, the port to which the peripheral device 202 is connected. In one embodiment, in which a Microsoft Windows operating system is executing on the client computer 204, the web browser 100 and/or the software component 212 downloaded by the browser 100 and which runs in the browser 100 may identify the peripheral device 202, through the peripheral device driver 214, as follows. As shown in FIG. 2A, the client computer 204 includes multiple ports 206a-c (three ports are shown for purposes of example). These ports 206a-c may, for example be serial ports. The peripheral device driver 214 may interrogate each of the ports 206a-c using standard commands provided by the Windows operating system. These commands indicate, for each of the ports 206a-c, whether a peripheral device is connected to the port and, if so, provide an identifier (ID) of the peripheral device. Peripheral device manufacturers configure their peripheral devices with IDs that are intended (although not guaranteed) to be unique. The web browser 100 and/or the software component 212 downloaded by the browser 100 and which runs in the browser 100 may compare any peripheral device IDs obtained using the operating system commands to the ID of the peripheral device selected by the user. If the ID of a peripheral device connected to a particular one of the ports 206a-c is the same as the ID of the peripheral device selected by the user, the peripheral device driver 214 may determine that the peripheral device selected by the user is connected to the particular one of the ports 206a-c.

Alternatively, if the user does not select a peripheral device, the peripheral device driver 214 may interrogate the ports 206a-c to obtain the device identifiers (if any) of the peripheral devices connected to the ports 206a-c. The peripheral device driver 214 may compare any device IDs obtained in this manner to a predetermined list of IDs for known peripheral devices. If a known peripheral device is found at one of the ports 206a-c in this manner, the peripheral device driver 214 may install an appropriate peripheral device driver for the identified peripheral device and perform subsequent communications with the peripheral device 202 through the identified one of the ports 206a-c.

As described above, in one embodiment, the web browser 100 and/or the software component 212 downloaded by the browser 100 and which runs in the browser 100 installs the peripheral device driver 214 without rebooting the client computer 204 (FIG. 3C, step 314). Referring to FIG. 4, in one embodiment the web browser 100 and/or the software component 212 downloaded by the browser 100 and which runs in the browser 100 performs this installation as follows. The web browser 100 and/or the software component 212 downloaded by the browser 100 and which runs in the browser 100 identifies a location of the peripheral device driver 214 (step 402). For example, referring to FIG. 2C, in one embodiment, a peripheral device driver server 222 maintains a store of peripheral device drivers 224 for a variety of peripheral devices. Each of the peripheral device drivers 224 is accessible over the TCP/IP network 108 using a particular Uniform Resource Locator (URL). The web browser 100 identifies the URL of the peripheral device driver 214 for the peripheral device 202 based on the identification of the peripheral device 202 performed in step 310, such as by looking up the URL in a table that associates peripheral device IDs with peripheral device driver URLs.

The web browser 100 and/or the software component 212 downloaded by the browser 100 and which runs in the browser 100 downloads the peripheral device driver 214 from the peripheral device driver server 222 (step 404), such as by sending a peripheral device driver request 220 for the peripheral device driver 214 to the peripheral device driver server 222 over the TCP/IP network 108. In response, the peripheral device driver server 222 sends the peripheral device driver 214 to the web browser 100 over the TCP/IP network 108. The web browser 100 and/or the software component 212 downloaded by the browser 100 and which runs in the browser 100 stores the peripheral device driver 214 in a predetermined location (step 406), such as in a predetermined directory on a hard disk drive accessible to the client computer 204.

Having downloaded the peripheral device driver 214 from the peripheral device driver server 222, the web browser 100 and/or the software component 212 downloaded by the browser 100 and which runs in the browser 100 may use the peripheral device driver 214 to communicate with the peripheral device 202, as described above, without rebooting the client computer 204 and without re-executing the web browser 100.

One advantage of using the device driver server 222 is that it may be used to eliminate the need for the user to provide the peripheral device driver 214 to the client computer 204 on a computer-readable medium such as a floppy disk or CD-ROM. Another advantage of using the device driver server 222 is that the user can connect the peripheral device to any computer without having to install a device driver, thereby gaining portability. This advantage enables applications such as that disclosed in U.S. patent application Ser. No. AA/AAA,AAA, “Method and System for Enabling the Use of Reloadable Single Use Digital Cameras, to be used in multiple computers.)

One embodiment of the peripheral device driver 214 is now described in more detail. It should be appreciated that different peripheral devices are manufactured to understand different sets of commands for performing various functions. The peripheral device driver 214 recognizes a set of commands defined according to an application program interface (API). The peripheral device driver 214 enables the web browser 100 and/or the software component 212 downloaded by the browser 100 and which runs in the browser 100 to communicate with a plurality of peripheral devices using the single set of commands defined by the peripheral device driver's API.

Referring to FIG. 5, the web browser 100 and/or the software component 212 downloaded by the browser 100 and which runs in the browser 100 may communicate with the peripheral device 202 by sending an API command 506 defined according to the API to the peripheral device driver 214, which translates the API command 506 into a direct device command 514 that is understood by the peripheral device 202. The peripheral device 202 processes the direct command 514 and responds to the peripheral device driver 214 with a direct device response 516, which is converted into an API command response 508. The direct device command 514 may be any command understood by the peripheral device 202.

The peripheral device driver 214 includes an application program interface (API) layer 502 that implements the standard set of commands for use by the web browser 100 as described above. Such commands may include for example, commands for transferring device data 210 from the peripheral device 202 to the client computer 204, for deleting device data 210 from the peripheral device 202, for downloading device data 210 to the peripheral device 202 and for obtaining information about the peripheral device 202 and the device data 210. When the web browser 100 and/or the software component 212 downloaded by the browser 100 and which runs in the browser 100 sends the API command 506 to the peripheral device driver 214, the API command 506 is received by the API layer 502, which converts the API command 506 into a low-level device command 510. The low-level device command 510 is defined according to a command set understood by a low-level device driver 504. The low-low device driver 504 is configured to communicate directly with the peripheral device 202 through the port 206a, and may be provided by the manufacturer of the peripheral device 202. The API layer 502 sends the low-level device command 510 to the low-level device driver 504, which processes the low-level device command 510 as appropriate. The low-level device driver 504 converts the low-level device command 510 into a direct device command 514 that is understood directly by the peripheral device 202.

The peripheral device 202 may respond to the direct device command 514 with a direct device response 516. The direct device response 516 may include, for example, some or all of the device data 210 and/or status information (such as an indication of whether the direct device command 514 was executed successfully). The low level-device driver 504 receives the direct device response 516 and translates it into a low-level device response 512 that is understood by the API layer 502. The API layer 502, in turn, translates the low-level device response 512 into an API command response 508 that (defined according to the peripheral device driver's API) and is delivered to the web browser 100. The API command response 508 may include, for example, part or all of the device data 210 and/or status information.

In one embodiment, the functionality of the API layer 502 is provided by the current web page 120 and therefore is transferred to the client computer 204 as part of the current web page 120; as a result, the API layer 502 need not be separately downloaded from the peripheral device driver server 222. Rather, in this embodiment, only the low-level device driver 504 is downloaded from the peripheral device driver server 222 to operate the peripheral device 202, since the functionality of the API layer 502 is already present on the client computer 204 within the current web page 120.

It should be appreciated that although only a single peripheral device 202 and a single low-level device driver 504 are shown in FIG. 5, there may be multiple peripheral devices and multiple corresponding low-level device drivers. For example, there may be a distinct low-level device driver for each peripheral device connected to the client computer 204. The single application layer 502 may be configured to act as an intermediary between the web browser 100 and the peripheral devices using the multiple low-level device drivers.

A particular embodiment of the present invention is now described in more detail. This embodiment uses features provided by version 1.1 and higher of the Java programming language and supported by web browsers such as Netscape Navigator (version 4.0.8 and higher, hereinafter “Navigator”) and Microsoft Internet Explorer (version 4.0.1 and higher, hereinafter “Internet Explorer”) web browsers on the Microsoft Windows platform. Although the Java programming language is implemented in slightly different ways within Navigator and Internet Explorer, those of ordinary skill in the art will be able to implement the features described below in either of the two web browsers based on the description herein.

According to this embodiment, the client computer 204 is a conventional desktop or laptop computer configured to run a Microsoft Windows operating system (such as Windows 95, Windows 98, Windows NT, or Windows 2000). The web browser 100 is a version of either Navigator or Internet Explorer that supports Java version 1.1 or higher. The peripheral device 202 is a single use digital camera (the single use digital camera described in U.S. patent application Ser. No. AA/AAA,AAA, Method and System for Enabling the Use of Reloadable Single Use Digital Camera) connected to the port 206a, which is a serial port of the client computer 204. The device data 210 includes one or more data items corresponding to images stored on a computer-readable medium, such as a memory of the peripheral device 202. The web site 112 is a web site designed to assist the user in manipulating (e.g. deleting, processing) data from the peripheral device 202 and in uploading the digital images from the client computer 204 to the processed device data database 230.

In this embodiment, the user acquires digital images using the single use digital camera and connects the single use digital camera to the port 206a of the client computer 204. For purposes of example, assume that a peripheral device driver for operating the single use digital camera is not installed on the client computer 204. In addition, assume for purposes of example that the URL of the home page of the web site 112 is known to the user. The user navigates to the home page of the web site 112 using the web browser 100, causing the home page to become the current web page 120. The web browser 100 renders the current web page 120 on an output device (not shown) such as a computer monitor.

In this embodiment, the current web page 120 includes an applet written according to the Java programming language. As used herein, the term “applet” refers to a computer program capable of execution within the web browser 100. For example, applets may be written in Sun Microsystem's Java™ programming language and be executed within conventional web browsers. An applet is typically embedded in (or referenced by) a web page (such as the current web page 120). When the web browser 100 displays a web page containing an applet, the web browser 100 downloads the applet's object code to the client computer 204 and executes the applet's object code. The output of applets is typically displayed within a rectangular region within the web page containing the applet. To embed an applet within a web page, an “applet” tag is typically provided within the source code of the web page that identifies a location of the applet's object code using a URL and optionally provides parameters to be provided to the applet.

It should be appreciated that applets are typically not installed on the client computer 204 in the same manner as application programs, such as the web browser 100, are installed on the client computer. For example, to install an application program in the Microsoft Windows operating system environment, the user typically executes an installation program on the client computer 204. The installation program copies the application program's files to the client computer's hard disk drive and may also perform other actions such as modifying the Windows Registry. Operation of the installation program typically requires the user to provide some input, such as specifying a directory in which the application program is to be installed. Some application programs require the client computer 204 to be rebooted after being installed. Installing an application program in Microsoft Windows may cause an existing DLL to be overwritten with a newer version of the DLL. This can sometimes cause backward compatibility problems with existing applications that were using the older version of the DLL.

Applets, on the other hand, are not typically installed on the client computer 204 by executing a separate installation program; rather, as described above, they are typically downloaded and executed automatically by the web browser 100 when a web page (such as the current web page 120) containing an applet is displayed by the web browser 100. Applets typically interact with the user (by displaying output and receiving input) through the same web browser window that displays the web page containing the applet. Furthermore, the download and execution of an applet typically does not require the installation of potentially conflicting DLLs and does not require the client computer 204 to be rebooted.

As a result of the features of applets described above, applets may be advantageously used to provide a streamlined process for installing the peripheral device driver 214, transferring the device data 210 to the client computer 204, processing the transferred device data 210 and/or uploading the processed device data 216 to the processed device data database 230. Because applets are executed within the web browser 100 rather than as separately executed application programs, applets typically include a smaller amount of data than a corresponding application program and therefore require less time to be downloaded than a corresponding application program. The small size results from the fact that the web browser 100, which is already installed on the client computer 204, provides much of the functionality required by the applet. Furthermore, since the user performs input and output through the web browser window, the entire process of installing the peripheral device driver 214, transferring the device data 210 from the peripheral device 202 to the client computer 204, processing to retrieve the data in image form, deleting the device data 210 from the peripheral device 202 to “reload” the single use digital camera, and uploading the processed device data to the processed device data database 230 may be performed within the same web browser window, thereby providing the user with a streamlined and simplified method for manipulating the device data 210 compared to conventional methods.

Applets are typically rendered by the web browser 100 within a predetermined rectangular region of the current web page 120. Applets may perform a variety of functions, such as displaying text and images and responding to user input. By default, applets are typically denied access to files accessible to the client computer 204 to prevent them from engaging in malicious activity, such as deleting files. However, the user may grant special privileges to an applet to enable the applet to access local files and perform other activities. The applet may be implemented as a signed applet to provide verification to the user that the applet originates from a trusted source and will not engage in malicious activity on the client computer 204. Upon receiving permission from the user to install the applet, the web browser 100 downloads the applet from the web server 110 and executes the applet, causing the applet to be displayed within the current web page 120.

Prior to downloading and installing the applet, computer program code (such as Java or Microsoft Active Server Pages (ASP) code in the server or JavaScript code in the browser) contained in or referenced by the current web page 120 may be executed on the client computer 204 and/or the web server 110, as appropriate, to perform functions such as determining the operating system of the client computer 204 and determining the model and version of the web browser 100. Different versions of the applet may be installed on the client computer 100 depending on the detected operating system and/or web browser. Code within the current web page 120 may also provide information to the applet when executing the applet, such as an identifier and/or password associated with the current user of the web browser 100. The applet may subsequently use such an identifier and/or password when uploading digital images to upload the digital images to the user's account or to a specific directory or URL corresponding to the user.

The applet identifies the peripheral device 202, as described above (FIG. 3C, step 310). After the applet identifies the peripheral device 202, the applet determines whether a peripheral device driver for operating the peripheral device 202 is installed on the client computer 204 (FIG. 3C, step 312). To make this determination, the applet stores any installed peripheral device drivers in predetermined directories (or in one predetermined directory with different driver file names) on the local hard disk drive of the client computer 204. Each directory (or each driver file) has a unique name that identifies the peripheral device to which it corresponds. As a result, the applet may determine whether the driver software corresponding to a particular peripheral device is installed on the client computer 204 by determining whether the directory corresponding to the peripheral device exists on the client computer 204 and by determining whether the correct peripheral device driver files are stored within the directory.

If the applet determines that the peripheral device driver for the digital camera is not installed on the client computer 204, the applet downloads the peripheral device driver 214 from the web server 110 and installs the peripheral device driver 214 on the client computer 204 without rebooting the client computer 204 (FIG. 3C step 314). The applet identifies the network address (URL) from which to download the peripheral device driver 214 by using a predetermined table that maps digital camera models to device driver URLs.

Before the applet installs the peripheral device driver 214 on the client computer 204, the applet creates a directory on the local hard disk drive of the client computer 204 for storage of the peripheral device driver 214. The applet transfers data corresponding to images stored in the single use digital camera to memory locations allocated to be used by the applet (hereafter called the applet's memory). The applet processes the data corresponding to images (which is not in image form) in order to render the data in image form. If the user desires to store the images in the client computer, the applet creates a directory on the local hard disk drive of the client computer 204 for storage of the images. If it is desired to upload the images to the (image) processed device data database 230, the applet uploads the image to the (image) processed device data database 230 in a manner that will be described in detail below.

Techniques that are used to transfer the digital images from the digital camera to the client computer 204 in one embodiment of the present invention are now described in more detail. Applications executing on the client computer 204 within the Microsoft Windows environment may communicate directly with serial ports (such as ports 206a-c) of the client computer 204 using low-level input/output (I/O) commands provided by the Microsoft Windows operating system. Such low-level I/O commands may be used to directly communicate with peripheral devices (such as the peripheral device 202) through the serial port 206a. As shown in FIG. 5, in one embodiment the peripheral device driver 214 is provided to communicate with the peripheral device 202 directly through the serial port 206a.

Java applets executing within the Microsoft Windows environment cannot directly access serial ports. For example, in one embodiment the port 206a is a serial port and the applet launches the peripheral device driver 214 as a Microsoft Windows application program that is capable of communicating with the serial port 206a as described above. The applet launches the peripheral device driver 214 Windows application using the Java Runtime.exec( ) method, and issues API commands to the peripheral device driver 214, which in turn communicates with the peripheral device 202 through the serial port 206a. The Runtime.exec( ) method returns a Java Process object that may be used for various purposes, some of which are described in more detail below. It should be appreciated that any references herein to communications by the applet with the serial port 206a should be considered to include communications by the applet with the serial port through 206a the peripheral device driver 214, where appropriate.

In one embodiment, the peripheral device driver 214 is implemented as a Windows application that includes only the functionality provided by the API layer 502. In this embodiment, the low-level device driver 504 is implemented as one or more Dynamic Link Libraries (DLLs) including object code for performing the functions provided by the low-level device driver 504. When the DLLs corresponding to the low-level device driver 504 are downloaded from the peripheral device driver server 222 (FIG. 2C), they are stored in the same directory as the Windows application corresponding to the peripheral device driver 214. As a result, there is no risk that the peripheral device driver DLLs will overwrite or conflict with other DLLs previously installed on the client computer 204. Furthermore, the DLLs are not registered in the Windows Registry. As a result, the client computer 204 need not be rebooted and the web browser 100 need not be re-executed after the DLLs are installed. The peripheral device driver Windows application may successfully call library routines within the downloaded DLLs because they are stored in the same directory as the Windows application. As a result, the downloaded DLLs (corresponding to the low-level device driver 504 in FIG. 5) may be installed on the client computer 204 and the Windows application (corresponding to the API layer 502 in FIG. 5) may communicate with the downloaded DLLs without rebooting the client computer 204 and without re-executing the web browser 100.

The applet may communicate with the peripheral device driver 214 using the conventional STDIN and STDOUT input and output streams that are recognized by the Windows operating system. Typically the STDIN stream receives input from the user through the keyboard and the STDOUT stream displays output in a window. Upon initialization, the applet may: (1) call the getInputStream( ) method of the Java Process object described above to obtain an input stream that receives data sent to the Windows STDOUT stream; and (2) call the getOutputStream( ) method of the Java Process object described above to obtain an output stream that may be used to send data to the Windows STDIN stream. As a result, the applet may transmit information (such as the API command 506) to the peripheral device driver 214 by outputting such information on the applet's output stream, and the peripheral device driver 214 may transmit information (such as the API command response 508 and data corresponding to images received from the peripheral device 202) to the applet by outputting such information on the peripheral device driver's STDOUT stream.

In one embodiment, the API command 506 and the API command response 508 are encoded in ASCII text to facilitate transmission using STDIN and STDOUT. For example, the API command 506 may be encoded in an ASCII text string wherein the first character of the string identifies the API command 506, followed by one or more command parameters separated by a predetermined separator character, such as the bar (“|”) character. Similarly, the API command response 508 may be encoded in an ASCII text string wherein the first character of the string identifies the API command 506 to which the API command response 508 is a response, followed by a status code (such as the numeral zero for success and any other digit for failure) and a status message. It should be appreciated that the API command 506 and the API command response 508 need not be encoded in ASCII. Rather, any method may be used to encode the API command and API command response for transmission using STDIN and STDOUT. For example, the API command 506 and the API command response 508 may be encoded as binary data.

The peripheral device driver 214 may effect the transmission of a data item corresponding to an image to the applet by storing the data item corresponding to an image in a file and transmitting the filename of the file to the applet in the API command response 508. The applet may subsequently retrieve the file using the transmitted filename. This allows the peripheral device driver 214 to effectively transmit the data item corresponding to an image without having to encode the data item corresponding to an image in the API command response 508.

Referring to FIG. 3D, a method that may be used to transfer data item corresponding to an image from the single use digital camera to the client computer 204 (FIG. 3C, step 316), to processes the data corresponding to images (which is not in image form) in order to render the data in image form and to upload the transferred digital images from the client computer 204 to the processed device data database 230 (FIG. 3B, step 345) is now described in more detail. The user initiates the transfer by providing user input 228 indicating a desire to start the process of retrieving the device data 210 from the peripheral device 202 (such as by clicking on a button displayed on the current web page 120). The applet transfers the data item corresponding to an image from the peripheral device 202 to the client computer 204 (step 322) by calling an appropriate API routine using the API command 506. The data item corresponding to an image is transferred directly from the peripheral device 202 to memory locations in the client computer 204 allocated to be used by the applet (the applet's memory) (step 322). The applet performs the processing operations necessary to render the data in image form (step 324) including thumbnail images.

The applet then displays the thumbnails in the rendition of the current web page 120 using techniques well-known to those of ordinary skill in the art. The user selects whether to store or upload the images (step 325). If uploading is selected, the user selects the images to upload (such as by clicking on a button displayed under each image on the current web page 120 ) (step 326). Then, for each selected image, the applet converts the image into the desired format (JPEG or another compressed format or uncompressed) within the applet's memory (step 328). Referring again to FIG. 3D, to upload the current image to the processed device data database 230 (FIG. 3A, step 306), the applet calls a “Submit” API function provided by the processed device data database 230 (step 334). This causes the image file (image.jpg) to be uploaded to and stored in the processed device data database 230. In one embodiment, the image file is uploaded using a socket connection that uploads the image file to the processed device data database 230 in binary form. In another embodiment, the image file is uploaded to the processed device data database 230 in ASCII form using HTTP.

If storing at the client computer 204 is selected, the user selects the images to store (such as by clicking on a button displayed under each image on the current web page 120) (step 332). Then, for each selected image, the applet converts the image into a given format, such as Windows Bitmap (BMP) format, within the applet's memory (step 334). The applet stores the current image in the transferred device data 216, such as by storing the current image on the client computer's hard disk drive in the given format (step 336).

After all the data items corresponding to images have been processed and rendered as images, if the user selects to “reload” the camera, the user provides user input 228 as to which of the data items to delete (such as by clicking on a “delete” button located by each of the images displayed on the current web page 120). Before the delete can be enabled, the user must provide payment for the continued re-use of the camera. The user input 228 that indicates that “reloading” is desired causes the web browser 100 to transmit an HTTPS request 104 to the server 232 to initiate a transaction for payment for “reloading”. The server 232 transmits back an HTTPS response 114. It should be apparent that more than one request/response sequence may be necessary to complete the transaction. At the completion of the transaction, the HTTP response 114 from the server 232 contains a result or indicator. Upon receipt of the indication of a successful transaction, the applet deletes the data items corresponding to the selected images from the peripheral device 202 by calling an appropriate API routine using the API command 506.

After uploading images to the processed device data database 230, the applet may provide the user with an option of uninstalling (removing) the peripheral device driver 214 (or the low-level device driver 504) from the client computer 204. If the user chooses not to delete the peripheral device driver 214, it will not be necessary to download the peripheral device driver 214 to the client computer 204 when the user next transfers images from the peripheral device 202 to the client computer 204.

It should be appreciated that the peripheral device driver 214 may be deleted from the client computer 204 without requiring the client computer 204 to be rebooted and/or without requiring the web browser 100 to be re-executed. Furthermore, the peripheral device driver 214 may be deleted without requiring the user to manually perform an uninstall operation. For example, in the embodiment described above in which the peripheral device driver 214 is implemented using DLLs that are not registered in the Windows Registry, the peripheral device driver 214 may be uninstalled from the client computer 204 by deleting the corresponding DLLs (and, optionally, the enclosing directory) from the client computer's hard disk drive. Because such deletion does not involve modification of the Windows Registry, it may be performed without rebooting the client computer 204 and without re-executing the web browser 100.

It should be apparent that the above example can involve more than one server—a server that hosts the software component 212 that will be downloaded to the web browser 100 at the client computer 204, a server that is contacted to perform the transaction, a peripheral device driver server 222, and the processed device data database 230 may be a web server for hosting online photo albums on the Web which may be distinct from the web server 110. These servers could be distinct, some could be combined or one server could access another server.

The techniques described herein may be used in the implementation of an embodiment of the single use digital camera described in U.S. patent application Ser. No. AA/AAA,AAA, “Method and System for Enabling the Use of Reloadable Single Use Digital Cameras.

It is to be understood that although the invention has been described above in terms of particular embodiments, the foregoing embodiments are provided as illustrative only, and do not limit or define the scope of the invention. Other embodiments are also within the scope of the present invention, which is defined by the scope of the claims below. Other embodiments that fall within the scope of the following claims includes include, but are not limited to, the following.

The client computer 204 may be any computer or device incorporating a computer processor, such as a desktop computer, laptop computer, Internet-capable cellular telephone, or Personal Digital Assistant (PDA).

As used herein, the peripheral device 202 refers to any device that may communicate with a computer, such as the client computer 204. For example, the peripheral device 202 may be a digital camera, scanner, hard disk drive, floppy disk drive, multi-function device (incorporating scanning, printing, copying, faxing, and/or digital image acquisition capabilities), or a digital audio device. The peripheral device 202 may be coupled to the client computer 204 using any connector, such as a serial cable, parallel cable, or wireless connection.

Although the foregoing examples use data corresponding to images as an example of device data 210, it should be appreciated that this is not a limitation of the present invention and that the device data 210 may include any kind of data, such as digital video, digital audio, digital multimedia streams, or any combination thereof.

The processed device data database 230 may, for example, be any database or storage medium capable of communicating with the client computer 204 over the TCP/IP network 108 and capable of storing some or all of the device data 210. For example, the processed device data database 230 may be a web server for hosting online photo albums on the Web. The processed device data database 230 may be distinct from the web server 110, or may be merged with the web server 110 to form a single web server for hosting the web site 112 and for storing the transferred device data 216.

The transaction data database 234 may, for example, be any database or storage medium capable of communicating with the client computer 204 over the TCP/IP network 108 and capable of storing transaction data. The transaction data database 234 may be a web server hosting applications for processing transactions. The web browser 100 may be any web browser or other HTTP client and may be implemented in hardware, software, firmware, or any combination thereof. For example, the web browser 100 may be a software application executing on a processor of a conventional desktop computer, laptop computer, handheld device, Personal Digital Assistant (PDA), cellular telephone, or any other device. The web browser 100 may, for example, be a commercially-available web browser such as the Navigator™ web browser available from Netscape Communications Corporation of Mountain View California or the Internet Explorer™ web browser available from Microsoft Corporation of Redmond Wash. Similarly, the web server 110 may be any HTTP server and is not limited to any particular implementation.

Certain parts of the description above refer to use of an applet to implement various aspects of the software component 212. It should be appreciated that the software component 212 refers not only to applets (such as applets written in the Java programming language) but to any software component that may be executed within the web browser 100. For example, the software component 212 may be implemented using the Java programming language, Microsoft's ActiveX technology, JavaScript, Microsoft VBScript, or any combination thereof.

It should be appreciated that although only the single current web page 120 is shown and described above, the current web page 120 refers to the web page that is currently displayed by the web browser 100 at any particular point in time and therefore may represent multiple web pages, such as multiple web pages within a web site. For example, in some of the embodiments described above, the current web page 120 may represent web pages within a web site for enabling the user to upload digital images from the peripheral device 202.

The TCP/IP network 108 may be any network, internet (such as the public Internet), intranet, extranet, subnetwork, or combination thereof that is capable of transmitting communications according to TCP/IP. The web browser 100 and web server 100 may be connected to the TCP/IP network 108 in any manner, such as by standard analog telephone lines, optical fiber, or a wireless network.

The peripheral device driver 214 may be implemented in any manner to enable the peripheral device driver 214 to operate the peripheral device 202 and to be installed on the client computer 204 without requiring rebooting of the client computer 204 and/or re-execution of the web browser 100. For example, in one embodiment the peripheral device driver 214 is implemented in the Microsoft Windows operating system environment as a collection of Dynamic Link Libraries (DLLs) that may be installed on the client computer 204 without requiring rebooting of the client computer 204 and/or re-execution of the web browser 100.

The peripheral device driver server 222 may be implemented in any manner to provide the peripheral device driver 214 to the web browser 100. For example, the peripheral device driver server 222 may be implemented as a web server that stores peripheral device drivers at predetermined URLs and therefore may be used to obtain a particular peripheral device driver by accessing the peripheral device driver's URL using the web browser 100. For example, the web site 112 may include peripheral device drivers accessible at predetermined URLs, in which case the functionality of the peripheral device driver server 222 is provided by the web site 112 in conjunction with the web server 110.

In general, the methods described herein relate to n-tier client/server systems and can be used with any technology used to implement n-tier client/server systems. For example, it should be apparent that any of the technologies described in R. Orfall and D. Harkey, “Client/Server Programming with Java and CORBA” (ISBN 0-471-24578-X) can be used (R. Orfall and D. Harkey, “Client/Server Programming with Java and CORBA”, particularly, pp. 186-371, and pp. 849-883).

In general, the techniques described above may be implemented, for example, in hardware, software, firmware, or any combination thereof The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program may be implemented in any programming language, such as assembly language, machine language, a high-level procedural programming language, or an object-oriented programming language. The programming language may be a compiled or interpreted programming language.

Each computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output.

What is claimed is:

1. A computer-implemented method for manipulating information in a peripheral device connected to a client computer, the method comprising steps of:
(A) executing a software component within a client application executing on the client computer, said software component being able to provide outputs to and receive inputs from at least one of a plurality of servers; and
(B) receiving data from a server from the at least one of a plurality of servers; and
(C) manipulating the information in the peripheral device upon receiving said data.

2. The method of claim 1, further comprising the steps of:
(D) prior to step (B), initiating a transaction with said server; and
wherein step (B) further comprises the step of receiving confirmation of said transaction.

3. The method of claim 1, further comprising a step of:
(D) using the software component to install a peripheral device driver for operating the peripheral device on the client computer without re-executing the client application.

4. The method of claim 1, further comprising a step of:
(D) uploading the information from the client computer to a web server.

5. The method of claim 4 wherein the step (D) comprises a step of using the software component to upload the information from the client computer to the web server.

6. The method of claim 1, further comprising a step of:
(D) processing the information at the client computer;
(E) uploading the processed information from the client computer to a web server.

7. The method of claim 6 wherein the step (E) comprises a step of using the software component to upload the information from the client computer to the web server.

8. The method of claim 1, further comprising a step of:
(C) prior to performing the step (A), installing the software component on the client computer.

9. The method of claim 8, further comprising a step of:
(D) after performing the step (C), uninstalling the software component from the client computer.

10. The method of claim 3, wherein the step (D) comprises steps of:
(D) (1) determining whether the peripheral device driver is already installed on the client computer; and
(D) (2) using the software component to install the peripheral device driver on the client computer if it is determined that the peripheral device driver is not already installed on the client computer.

11. The method of claim 1, wherein the client application comprises a web browser.

12. The method of claim 11, wherein the software component comprises a Java applet.

13. The method of claim 11, wherein the software component comprises an ActiveX control.

14. The method of claim 1, wherein the information comprises at least one data item corresponding to an image.

15. The method of claim 14, wherein the peripheral device comprises a digital image acquisition device.

16. A computer-implemented method for deleting information from a storage component in a peripheral device connected to a client computer, the method comprising steps of:
(A) installing a software component for execution in a web browser executing on the client computer without re-executing the web browser, said software component being able to provide outputs to and receive inputs from a web server;
(B) using the software component to install a peripheral device driver for operating the peripheral device on the client computer without re-executing the web browser;
(C) receiving data from the web server;
(D) upon receiving the data from the web server, using the software component to delete the digital image from the storage component in the peripheral device by using the peripheral device driver.

17. The method of claim 16 further comprising the step of:
(E) prior to step (C), initiating a transaction with a service at the server;
and, wherein step (C) further comprises the step of receiving confirmation of said transaction.

18. The method of claim 16, further comprising steps of:
(E) determining whether the peripheral device driver is already installed on the client computer; and
(F) performing step (B) if it is determined that the peripheral device driver is not already installed on the client computer.

19. The method of claim 16, wherein the information comprises at least one data item corresponding to an image.

20. The method of claim 19, wherein the peripheral device comprises a digital image acquisition device.

21. An apparatus for manipulating information in a peripheral device connected to a client computer, said apparatus comprising:
means for executing a software component within a client application executing on the client computer, said software component being able to provide outputs to and receive inputs from at least one of a plurality of servers; and
means for receiving data from a server from the at least one of a plurality of servers; and
means for manipulating the information in the peripheral device upon receiving said data.

22. The apparatus of claim 21 further comprising:
means for initiating a transaction with said server; and
wherein the means for receiving data from a server further comprises means for receiving confirmation of said transaction.

23. The apparatus of claim 21 further comprising:
means for using the software component to install a peripheral device driver for operating the peripheral device on the client computer without re-executing the client application.

24. The apparatus of claim 21 further comprising:
means for uploading the information from the client computer to a web server.

25. The apparatus of claim 24 wherein the means for uploading the information from the client computer to the web server utilize the software component to upload the information.

26. The apparatus of claim 21 further comprising:
means for processing the information at the client computer; and
means for uploading the processed information from the client computer to a web server.

27. The apparatus of claim 26 wherein the means for uploading the processed information from the client computer to the web server utilize the software component to upload the information.

28. The apparatus of claim 21 further comprising:
means for installing the software component on the client computer.

29. The apparatus of claim 28 further comprising:
means for uninstalling the software component from the client computer.

30. The apparatus of claim 23 further comprising:
means for determining whether the peripheral device driver is already installed on the client computer.

31. An apparatus for deleting information from a storage component in a peripheral device connected to a client computer, said apparatus comprising:
means for installing a software component for execution in a web browser executing on the client computer without re-executing the web browser, said software component being able to provide outputs to and receive inputs from a web server; and
means for using the software component to install a peripheral device driver for operating the peripheral device on the client computer without re-executing the web browser; and
means for receiving data from the web server; and
means for using the software component to delete the digital image from the storage component in the peripheral device by using the peripheral device driver upon receiving the data from the web server.

32. The apparatus of claim 31 further comprising:
means for initiating a transaction with said server; and
wherein the means for receiving data from a server further comprises means for receiving confirmation of said transaction.

33. The apparatus of claim 31 further comprising:
means for determining whether the peripheral device driver is already installed on the client computer.
